(19) United States
(12) Patent Application Publication
(10) Pub. No.: US 2019/0108491 A1
(43) Pub. Date: Apr. 11, 2019

(54) AUTOMATICALLY MAINTAINING A SOCIAL MEDIA EVENT DATABASE

(71) Applicant: BlackBook Media Inc., Quincy, MA (US)

(72) Inventors: Scott Herman Albertine, Cambridge, MA (US); K. Viktor Golubic, Quincy, MA (US); Thomas Joseph Huber, II, Medford, MA (US)

(21) Appl. No.: 15/727,023

(22) Filed: Oct. 6, 2017

(51) Int. Cl. G06Q 10/10; G06Q 50/00; H04L 29/08; H04W 4/08

(52) U.S. Cl. CPC G06Q 10/1093; H04W 4/08; H04L 67/24; G06Q 50/01

(57) ABSTRACT

In an example method, a system receives a social media event template including template social media event content and an indication of a recurring schedule. The system generates a series of social media event items in a calendar database based on the social media event template. The system receives a command indicating a modified recurring schedule for the social media event template. In response, the system identifies a particular social media event item that has been previously modified but has a start time that has not been modified. The system generates a notification to the controlling user of the particular social media event item to provide a modified start time for the particular social media event item.

### TECHNICAL FIELD

This disclosure relates to maintaining database systems, and more specifically to maintaining a database of social media events, e.g., for use with social media platforms enabling users to create social media events in an automated manner.

### BACKGROUND

A database (e.g., a relational database or another kind of database) can store a variety of data, e.g., data generated and maintained by a social media platform. A social media platform is an online platform that enables users to build social networks and/or social relationships with other users. For instance, a user can establish an online persona or identity on the social media platform, and use the persona or identity to interact with other users. As an example, a user can create a user alias by inputting personal information, biographical information, and/or other information regarding himself (e.g., name, contact information, personal interests, job information, photographs, videos, audio, etc.). Further, a user can associate himself with other users of the social media platform (e.g., by specifying one or more users that are acquaintances, business connections, and/or friends).

In some cases, a social media platform also enables users to share information with one another. For example, in some social media platforms, users can transmit messages, photographs, videos, audio, documents, and/or other content to one another via the social media platform.

In some cases, a social media platform also enables users to promote and organize events. For example, in some social media platforms, a user can input information regarding an upcoming event, and share the information with other users. Recipients can review information regarding the event, discuss the event, and/or RSVP to the event.

### SUMMARY

A social media platform can enable a user to promote and organize events in an automated manner. For example, a user can interact with the social media platform to create an event template for a recurring series of events. The user can populate the event template with information common to each of the events in the series. Further, the user can specify a recurring schedule for the events. Based on the event template, the social media platform generates a series of social media event items. In turn, the user can publicize the social media event items, such that they are accessible to other users.

In some cases, a user can modify one or more of the social media event items individually. In some cases, a user can modify the event template, such that two or more of the social media event items in the series are modified in conjunction.

In some cases, a user can modify the recurring schedule in the event template. In response, the social media platform can reschedule one or more of the events in the series to reflect the modified schedule. Further, instead of simply modifying each and every event in the series to reflect the new schedule, the social media platform can selectively reschedule one or more of the events in the series according to one or more data processing rules, such that the events are automatically rescheduled in a manner that is more useful for the user. Further, the social media platform can automatically identify one or more event conflicts resulting from the modification, and notify the user of the conflicts such that the user can address them.

In an aspect, a method includes receiving, at a server system, a social media event template. The social media event template includes template social media event content, and an indication of a recurring schedule. The method also includes generating, by the server system in a calendar database, a series of social media event items based on the social media event template. Each social media event item includes an indication of a start time and a duration of the social media event item according to the recurring schedule, a copy of the template social media event content, and an indication of a state of the social media event item. Each state is one of an inactive state indicating that the social media event item is accessible by a controlling user of the social media event item and hidden from one or more general users, and an active state indicating that the social media event item is accessible by the controlling user of the social media event item and accessible by the one or more general users. The method also includes receiving, at the server system, one or more first commands. Each of the one or more first commands includes an indication of a respective modification to one of the social media event item of the series of social media event items. The method also includes, responsive to receiving the one or more first commands, modifying one or more of the social media event items of the series of social media event items according to the one or more first commands. The method also includes receiving, at the server system, a second command. The second command includes an indication of a modified recurring schedule for the social media event template. The method also includes, responsive to receiving the second command, identifying one or more first social media event items of the series of social media event items that have not been modified according to the one or more first commands, each first social media event item having an inactive state, identifying one or more second social media event items of the series of social media event items that have been modified according to the one or more first commands, each second social media event item having a start time that has not been modified according to the one or more first commands, each second social media event item having an inactive state, and each second social media event item differing from the modified recurring schedule, and generating, for each of the one or more second social media event items, a notification to the controlling user of the second social media event item. The notification prompts the controlling user to provide a modified start time for the second social media event item. The method also includes, responsive to receiving the second command, receiving, for each of the one or more second social media event items, a response from the controlling user of the second social media event item specifying the modified start time. The method also includes, subsequent to generating the notification and receiving the response for each of the one or more second social media event items, deleting the one or more first social media event items, and adding one or more additional social media event items to the series of social media event items based on the modified recurring schedule.

Implementations of this aspect can include one or more of the following features.

In some implementations, adding the one or more additional social media event items to the series of social media event items can include determining that the series of social media event items does not include one or more social media event items corresponding to the modified recurring schedule, and based on the determination, adding the one or more additional social media event items to the series of social media event items corresponding to the modified recurring schedule.

In some implementations, each social media event item can be initially assigned an inactive state upon generation.

In some implementations, the method can further include receiving, at the server system, a command to activate a particular social media event item, and responsive to receiving the command to activate the particular social media event item, assigning the particular social media event item an active state.

In some implementations, the notification can further include a user selectable option to delete the second social media event item.

In some implementations, the indication of the recurring schedule can include an indication of one or more recurring days of week.

In some implementations, the indication of the recurring schedule can include an indication of one or more recurring times.

In some implementations, the indication of the recurring schedule can include an indication of a frequency of occurrence.

In some implementations, the template social media event content can include at least one of text, an image, a video, or audio pertaining to the series of social media event items.

In another aspect, a method includes receiving, at a server system, a social media event template. The social media event template includes template social media event content, and an indication of a recurring schedule. The method also includes generating, by the server system in a calendar database, a series of social media event items based on the social media event template. Each social media event item includes an indication of a start time and a duration of the social media event item according to the recurring schedule, and a copy of the template social media event content. The method also includes receiving, at the server system, one or more first commands. Each of the one or more first commands includes an indication of a respective modification to one of the social media event item of the series of social media event items. The method also includes, responsive to receiving the one or more first commands, modifying one or more of the social media event items of the series of social media event items according to the one or more first commands. The method also includes receiving, at the server system, a second command. The second command includes an indication of a modified recurring schedule for the social media event template. The method also includes, responsive to receiving the second command. identifying a particular social media event item of the series of social media event items based on a determination that the particular social media event item that has been modified according to the one or more first commands and has a start time that has not been modified according to the one or more first commands, and generating, for the particular social media event item, a notification to the controlling user of the particular social media event item, the notification prompting the controlling user to provide a modified start time for the particular social media event item.

Implementations of this aspect can include one or more of the following features.

In some implementations, each social media event item can further include an indication of a state of the social media event item. Each state can be one of an inactive state indicating that the social media event item is accessible by a controlling user of the social media event item and hidden from one or more general users, and an active state indicating that the social media event item is accessible by the controlling user of the social media event item and accessible by the one or more general users. Identifying the particular social media event item of the series of social media event item can be further based on a determination that the particular social media event item has an inactive state.

In some implementations, the method can further include identifying a second social media event item of the series of social media event items that has not been modified according to the one or more first commands, the second social media event item having an inactive state, and deleting the second social media event item.

In some implementations, deleting the second social media event item can occur subsequent to generating the notification to the controlling user of the particular social media event item and receiving a response from the controlling user specifying the modified start time.

In some implementations, each social media event item can be initially assigned an inactive state upon generation.

In some implementations, the method can further include receiving, at the server system, a command to activate one of the social media event items, and responsive to receiving the command, assigning that social media event item an active state.

In some implementations, the notification can further include a user selectable option to delete the particular social media event item.

In some implementations, the method can further include receiving the modified start time from the controlling user of the particular social media event item, and modifying the particular social media event item based on the received modified start time.

In some implementations, the method can further include adding one or more additional social media event items to the series of social media event items based on the modified recurring schedule.

In some implementations, adding the one or more additional social media event items to the series of social media event items can occur subsequent to generating the notification to the controlling user of the particular social media event item and receiving a response from the controlling user specifying the modified start time.

In another aspect, a non-transitory computer-readable medium includes one or more sequences of instructions which, when executed by one or more processors, causes various operations. The operations include receiving, at a server system, a social media event template. The social media event template includes template social media event content, and an indication of a recurring schedule. The operations also include generating, by the server system in a calendar database, a series of social media event items based on the social media event template. Each social media event item includes an indication of a start time and a duration of the social media event item according to the recurring schedule, a copy of the template social media event content, and an indication of a state of the social media event item. Each state is one of an inactive state indicating that the social media event item is accessible by a controlling user of the social media event item and hidden from one or more general users, and an active state indicating that the social media event item is accessible by the controlling user of the social media event item and accessible by the one or more general users. The operations also include receiving, at the server system, one or more first commands. Each of the one or more first commands includes an indication of a respective modification to one of the social media event item of the series of social media event items. The operations also include, responsive to receiving the one or more first commands, modifying one or more of the social media event items of the series of social media event items according to the one or more first commands. The operations also include receiving, at the server system, a second command, the second command comprising an indication of a modified recurring schedule for the social media event template. The operations also include, responsive to receiving the second command, identifying one or more first social media event items of the series of social media events that have not been modified according to the one or more first commands, each first social media event item having an inactive state, and identifying one or more second social media event items of the series of social media event items that have been modified according to the one or more first commands, each second social media event item having a start time that has not been modified according to the one or more first commands, each second social media event item having an inactive state, and each second social media event item differing from the modified recurring schedule, The operations also include, responsive to receiving the second command, generating, for each of the one or more second social media event items, a notification to the controlling user of the second social media event item, the notification prompting the controlling user to provide a modified start time for the second social media event item, and receiving, for each of the one or more second social media event items, a response from the controlling user of the second social media event item specifying the modified start time. The operations also include, subsequent to generating the notification and receiving the response for each of the one or more second social media event items, deleting the one or more first social media event items, and adding one or more additional social media event items to the series of social media event items based on the modified recurring schedule.

In another aspect, a non-transitory computer-readable medium includes one or more sequences of instructions which, when executed by one or more processors, causes various operations. The operations include receiving, at a server system, a social media event template. The social media event template includes template social media event content, and an indication of a recurring schedule. The operations also include generating, by the server system in a calendar database, a series of social media event items based on the social media event template. Each social media event item includes an indication of a start time and a duration of the social media event item according to the recurring schedule, and a copy of the template social media event content. The operations also include receiving, at the server system, one or more first commands. Each of the one or more first commands includes an indication of a respective modification to one of the social media event item of the series of social media event items. The operations also include, responsive to receiving the one or more first commands, modifying one or more of the social media event items of the series of social media event items according to the one or more first commands. The operations also include receiving, at the server system, a second command, the second command comprising an indication of a modified recurring schedule for the social media event template. The operations also include, responsive to receiving the second command, identifying a particular social media event item of the series of social media event items based on a determination that the particular social media event item that has been modified according to the one or more first commands and has a start time that has not been modified according to the one or more first commands, and generating, for the particular social media event item, a notification to the controlling user of the particular social media event item, the notification prompting the controlling user to provide a modified start time for the particular social media event item.

One or more of the implementations described herein can provide various technical benefits. For example, implementations of a social media platform can enable users to quickly and efficiently create, modify, and distribute event information over a computerized communications network. For instance, using the social media platform, a user can automate the process of creating, modifying, and distributing event information for multiple different events at once. As the user can perform these tasks using fewer inputs (e.g., compared to manually providing information regarding events individually), the computational and network resources utilized by the user's device are reduced. Further, implementations of the social media platform receive, process, store, and/or transmit data according to specific data processing rules, thereby enabling the social media platform to operate consistently, reliably, and efficiently, and produce results that otherwise could not be achieved using traditional techniques.

The details of one or more embodiments are set forth in the accompanying drawings and the description below. Other features and advantages will be apparent from the description and drawings, and from the claims.

### DESCRIPTION OF DRAWINGS

FIG. 1 is a diagram of an example system for implementing social media platform.

FIG. 2 is a diagram of an example social media platform.

FIGS. 3A-3H are diagrams showing an example usage of a social media platform to promote and organize events in an automated manner.

FIG. 4 is a flow diagram of an example process for generating and modifying a series of event items.

FIG. 5 is a diagram of an example computer system.

Like reference symbols in the various drawings indicate like elements.

### DETAILED DESCRIPTION

A social media platform can enable a user to promote and organize events in an automated manner. For example, a user can interact with the social media platform to create an event template for a recurring series of events. The user can populate the event template with information common to each of the events in the series (e.g., textual information, images, videos, audio, or other content relating to the events). Further, the user can specify a recurring schedule for the events (e.g., every Friday at 8 PM). Based on the event template, the social media platform generates a series of social media event items. A social media event item is a portion of data representing a social media event, and typically includes data such as the date and time of the social media event, a description of the social media event, and one or more social media profiles (e.g., corresponding to the user who generated the social media event and other users of the social media system) associated with the social media event.

Social media event items are typically stored in a database associated with the social media platform. Maintaining this database may sometimes include the use of data processing rules specific to the data representing social media events, e.g., the social media event items.

After social media event items have been generated, the user can publicize the social media events corresponding to the respective social media event items, such that they are accessible to other users. For example, the user can share the social media events with others using the social media platform. Recipients can review information regarding the event, discuss the event, and/or RSVP to the event. In response, the social media platform updates the data representing the social media event stored in the associated database.

In some cases, a user can modify one or more of the social media event items individually. For instance, the user can add additional information regarding a particular event, revise information regarding a particular event, or remove information regarding a particular event. In some cases, a user can reschedule a particular event. In response, the social media platform can modify the corresponding social media event item to reflect the changes.

In some cases, a user can modify the event template, such that two or more of the social media event items in the series are modified in conjunction. For instance, the user can add additional information regarding the events, revise information regarding the events, or remove information regarding the events. In response, the social media platform can modify the corresponding social media event item to reflect the changes. This can be beneficial, for example, as it enables the user to modify multiple event items more quickly and efficiently.

In some cases, a user can also modify the recurring schedule in the event template. In response, the social media platform can reschedule one or more of the events in the series to reflect the modified schedule. Further, instead of simply modifying each and every event in the series to reflect the new schedule, the social media platform can selectively reschedule one or more of the events in the series according to one or more data processing rules, such that the events are automatically rescheduled in a manner that is more useful for the user. Further, the social media platform can automatically identify one or more event conflicts resulting from the modification, and notify the user of the conflicts such that the user can address them.

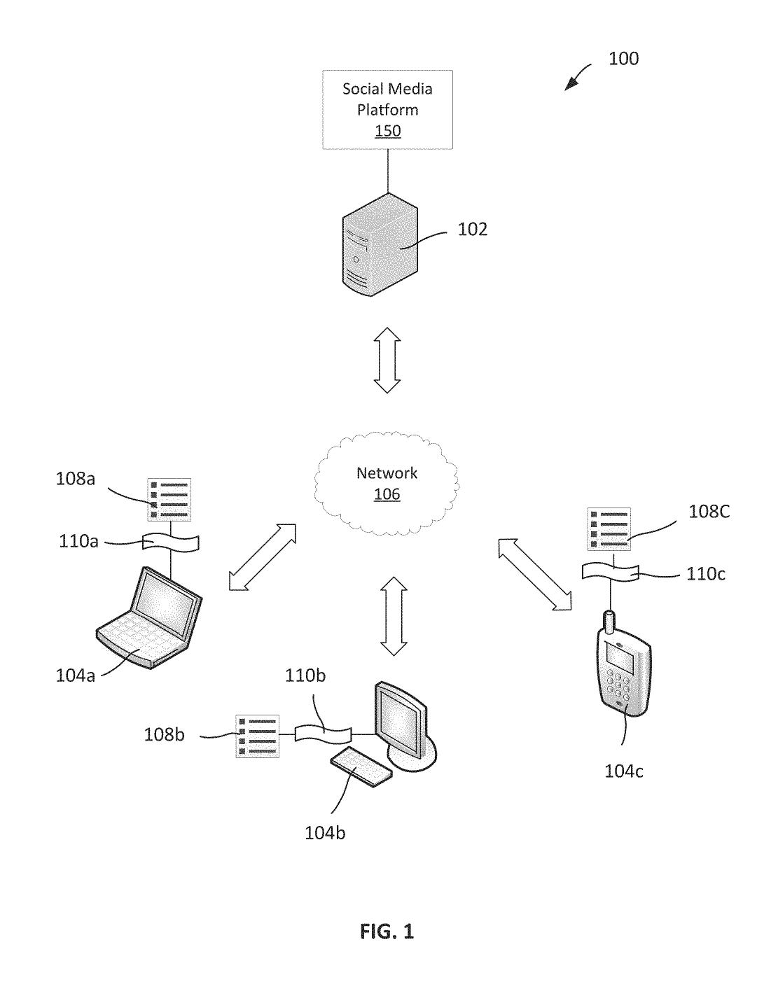

An example system 100 for implementing a social media platform is shown in FIG. 1. The system 100 includes a social media platform 150 maintained on a server system 102 that includes one or more server computers.

The server system 102 is communicatively connected to client devices 104a-c using the network 106. Each client device 104a-c includes a respective user interface 108a-c. Users interact with the user interfaces 108a-c to view data (e.g., data on the server system 102 and the platform 150, and/or data on other the client devices 104a-c). Users also interact with the user interfaces 108a-c to transmit data to other devices (e.g., to the server system 102 and the platform 150, and/or to the other client devices 104a-c). Users interact with the user interfaces 108a-c to issue commands 110a-c (e.g., to the server system 102 and the platform 150, and/or to the other client devices 104a-c). Commands 110a-c can be, for example, any user instruction to the server system 102 and/or to the other client devices 104a-c. In some implementations, a user can install a software application onto a client device 104a-c in order to facilitate performance of these tasks.

A client device 104a-c can be any electronic device that is used by a user to view, process, transmit and receive data. Examples of the client devices 104a-c include computers (such as desktop computers, notebook computers, server systems, etc.), mobile computing devices (such as cellular phones, smartphones, tablets, personal data assistants, notebook computers with networking capability), and other computing devices capable of transmitting and receiving data from the network 106. The client devices 104a-c can include devices that operate using one or more operating system (e.g., Microsoft Windows, Apple OS X, Linux, Unix, Android, Apple iOS, etc.) and/or architectures (e.g., x86, PowerPC, ARM, etc.) In some implementations, one or more of the client devices 104a-c need not be located locally with respect to the rest of the system 100, and one or more of the client devices 104a-c can be located in one or more remote physical locations. In some implementations, the client devices 104a-c can communicate with a geo-positioning system (e.g., a global positioning system [GPS], Wi-Fi triangular system, and so forth) in order to determine its geographical location.

The network 106 can be any communications network through which data can be transferred and shared. For example, the network 106 can be a local area network (LAN) or a wide-area network (WAN), such as the Internet. The network 106 can be implemented using various networking interfaces, for instance wireless networking interfaces (such as Wi-Fi, Bluetooth, or infrared) or wired networking interfaces (such as Ethernet or serial connection). The network 106 also can include combinations of more than one network, and can be implemented using one or more networking interfaces.

The server system 102 is illustrated as a respective single component. However, in practice, it can be implemented on one or more computing devices (e.g., each computing device including at least one processor such as a microprocessor or microcontroller). A server system 102 can be, for instance, a single computing device that is connected to the network 106, and a social media platform 150 can be maintained and operated on the single computing device. In some implementations, the server system 102 can include multiple computing devices that are connected to the network 106, and a social media platform 150 can be maintained and operated on some or all of the computing devices. For instance, the server system 102 can include several computing devices, and the platform 150 can be distributive on one or more of these computing devices. In some implementations, the server system 102 need not be located locally to the rest of the system 100, and portions of a server system 102 can be located in one or more remote physical locations.

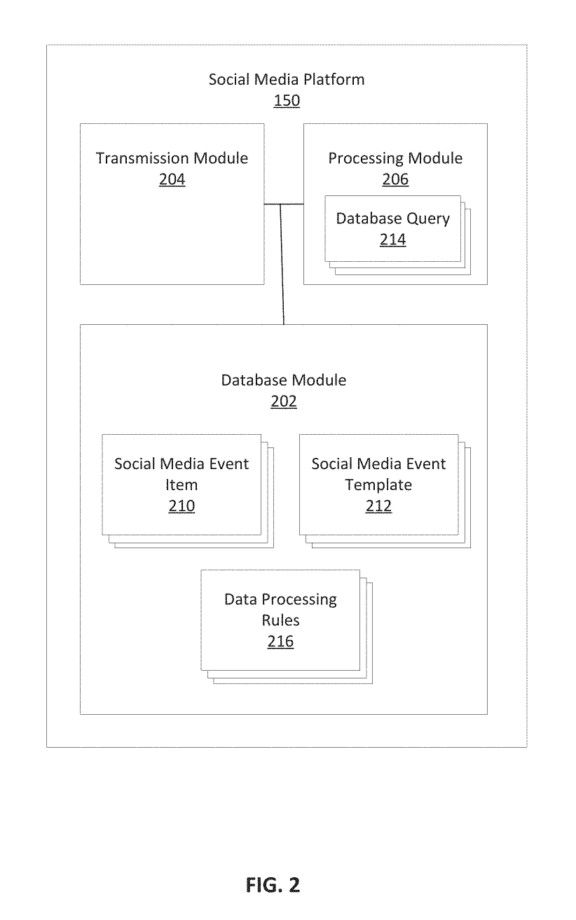

FIG. 2 shows various aspects of the platform 150. The platform 150 includes several modules that perform particular functions related to the operation of the system 100. For example, the platform 150 can include a database module 202, a transmission module 204, and a processing module 206.

The database module 202 maintains information related to one or more users of the system 100. As examples, the database module 202 can store information regarding a user's identity credentials (e.g., user name and password), contact information (e.g., e-mail address, physical address, phone number, and so forth), demographic information (e.g., age, gender, geographical region, and so forth), preferences (e.g., system preferences), location (e.g., geographical coordinates, such as those determined using a global positioning system (GPS), Wi-Fi triangulation system, or other geo-positioning system), relationship information (e.g., indications of a user's association with other users, an indication of links between social media aliases, etc.), and other user information (e.g., collections of the user's written content, photographs, videos, audio content, and so forth).

The database module 202 can also store information regarding one or more events. As an example, each event can be represented as a respective social media event item 210. Each social media event item 210 can include scheduling information regarding the event. For example, the social media event item 210 can specify the time at which an event is scheduled to occur (e.g., a date and a time of day), a scheduled duration of the event, and/or the time at which an event is scheduled to end. Each social media event item 210 can include content regarding the event. For example, the social media event item 210 can include textual information, images, videos, audio, or other content relating to the event. Each social media event item 210 can also include information regarding the users responsible for controlling the event (e.g., “controlling users”) and/or invitees to the event. For example, the social media event item 210 can indicate one or more controlling users of the event (e.g., one or more users responsible for creating, organizing, scheduling, rescheduling, administrating, and/or publicizing the event) and/or one or more users who have been invited to the event. Each social media event item 210 can also include RSVP information regarding one or more of the invitees. For example, the social media event item 210 can indicate one or more users who have been invited to the event and a corresponding status of each invitee with respect to the event (e.g., invited to the event, declined the invitation, accepted the invitation, tentatively accepted the invitation, has not responded to the invitation, etc.).

The database module 202 can also store sets of template information common to two or more events. As an example, each set of template information can be represented by a respective social media event template 212. The user can populate each social media event template 212 with information common to each of the events in a particular series. Further, the user can specify a recurring schedule for those events. Based on the social media event template 212, the social media platform can generate a series of social media event items 210, with each social media event item 210 in the series including a copy of the set of template information of the social media event template 212. Each social media event template 212 can specify the time and/or the frequency at which a series of events is scheduled to occur (e.g., a date and a time of day, a frequency of recurrence, etc.), a scheduled duration of the event, and/or the time at which an event is scheduled to end. Each social media event template 212 can include content regarding a series of events. For example, the social media event template 212 can include textual information, images, videos, audio, or other content relating to the series of events. Each social media event template 212 can also include information regarding the controlling users of the series of events and/or invitees to the series of events. For example, the social media event template 212 can indicate one or more controlling users of the series of events (e.g., one or more users responsible for creating, organizing, scheduling, rescheduling, administrating, and/or publicizing the series of events) and/or one or more users who have been invited to the series of events.

Although different examples of information are described above, these are merely illustrative. In practice, the database module 202 can store any information related to the users of the platform 150, scheduled events, or any other information pertaining to the platform 150.

Further, the database module 202 can execute database queries 214. Database queries can be, for example, commands that specify that particular data be retrieved, modified, and/or deleted from the database module 202. In response, the database module 202 can execute the queries to fulfill the request, or direct another component of the social media platform 150 to execute the query. In some cases, database queries 214 can be generated by the processing module 206 (e.g., based on a user's instructions), and transmitted to the database module 202 for execution. In some cases, database queries 214 can be generated and executed by the processing module 206 directly (e.g., the processing module 206 can directly retrieve, modify, and/or delete data stored in the database module 202).

In some cases, the database module 202 can process data stored in the database module 202 in accordance with one or more data processing rules 216. These data processing rules 216 can specify particular conditions and/or factors for processing data, such that the data stored in the database module 202 is more useful to a user and/or is stored more efficiently by the social media platform 150. As an example, the data processing rules 216 can specify how certain social media event items 212 can be modified based on a user's instructions. The data processing rules 216 also can be stored by the database module 202. Example implementations of the data processing rules 214 are discussed in greater detail below.

The transmission module 204 allows for the transmission of data to and from the platform 150. For example, the transmission module 204 can be communicatively connected to the network 106, such that it can transmit data to the client devices 104a-c, and receive data from the client devices 104a-c via the network 106. As an example, information inputted by users on the client devices 104a-c can be transmitted to the platform 150 through the transmission module 204. This information can then be processed (e.g., using the processing module 206) and/or stored (e.g., using the database module 202). As another example, information from the platform 150 (e.g., information stored on the database module 202) can be transmitted to the client devices 104a-c through transmission module 204.

The processing module 206 processes data stored or otherwise accessible to the platform 150. For instance, the processing module 206 can execute automated or user-initiated processes that manipulate data pertaining to one or more users or events. As an example, the processing module 206 can generate and then transmit database queries 214 to database module 202 to retrieve, modify, and/or delete data stored on the database module 202. As another example, the processing module 206 can generate and execute the database queries 214 directly (e.g., the processing module 206 can execute the database queries 214 to directly retrieve, modify, and/or delete data stored in the database module 202). Further, the processing module 206 can process data that is received from the transmission module 204. Likewise, processed data from the processing module 206 can be stored on the database module 202 (e.g., using one or more database queries 214) and/or sent to the transmission module 204 for transmission to other devices. Example processes that can be performed by the processing module 206 are described in greater detail below.

In some cases, the database module 202 and/or the processing module 206 can process data stored in the database module 202 in accordance with one or more data processing rules 216. These data processing rules 216 can specify particular operations that are performed with respect to the data stored by the database module 202 based on particular conditions, criteria, and/or factors. In some cases, data that is processed in accordance with these rules can be rendered more useful to a user and/or can be stored more efficiently by the social media platform 150. As an example, the data processing rules 216 can specify how certain social media event items 210 can be modified based on a user's instructions, and based on information contained within the social media event items 210 and/or the social media event templates 212. In some cases, the data processing rules 216 can be stored by the processing module 206 (e.g., so that the processing module 206 can directly access the processing rules 216). In some cases, the data processing rules 216 can be stored by the database module 202. Example implementations of the data processing rules 214 are discussed in greater detail below.

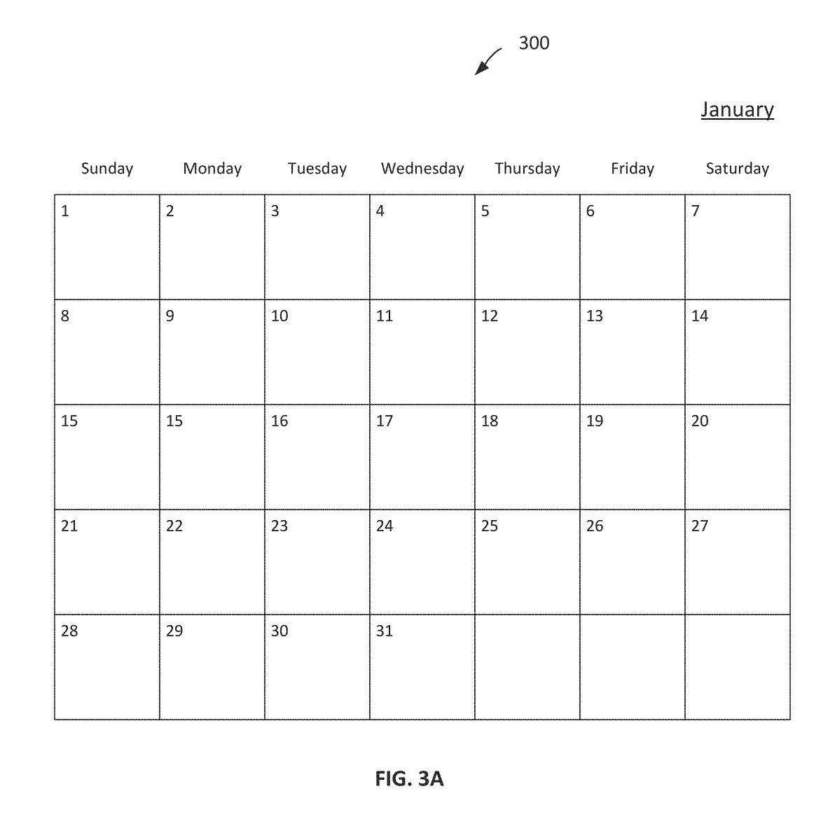

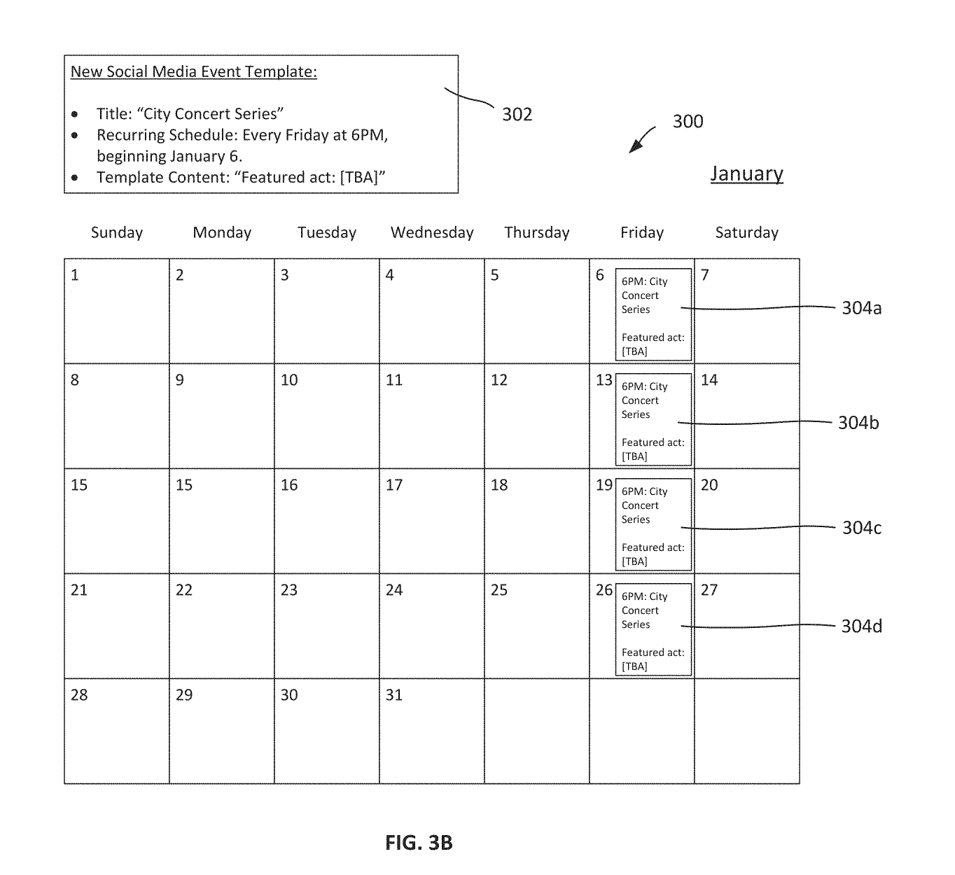

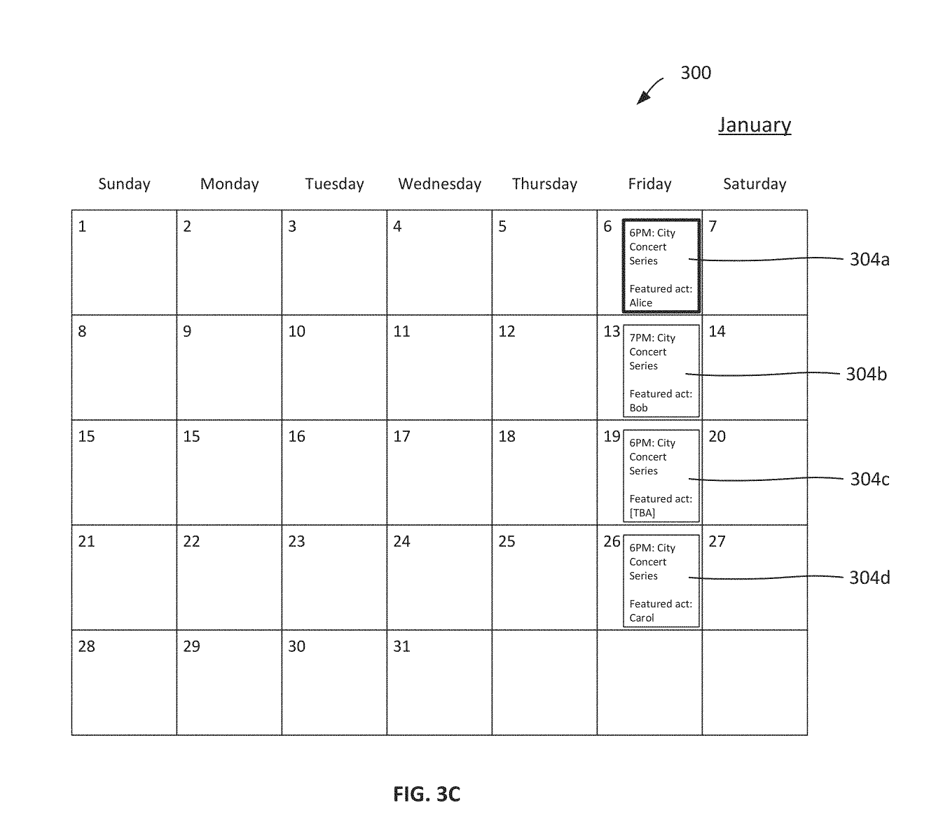

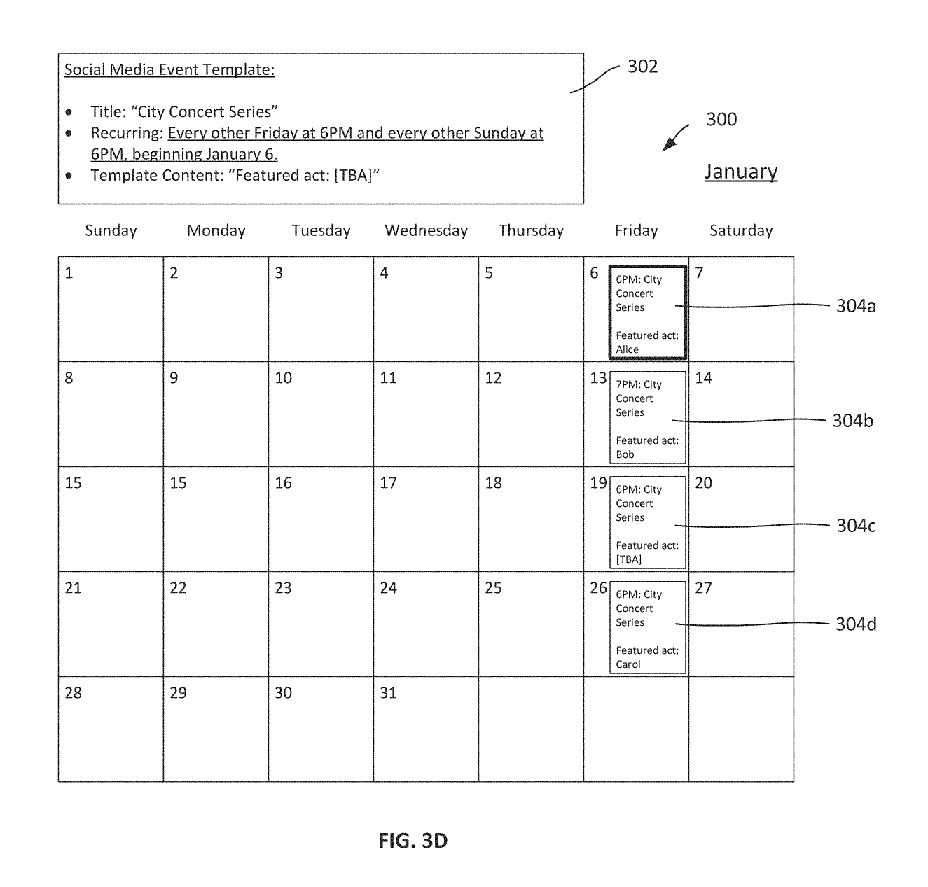

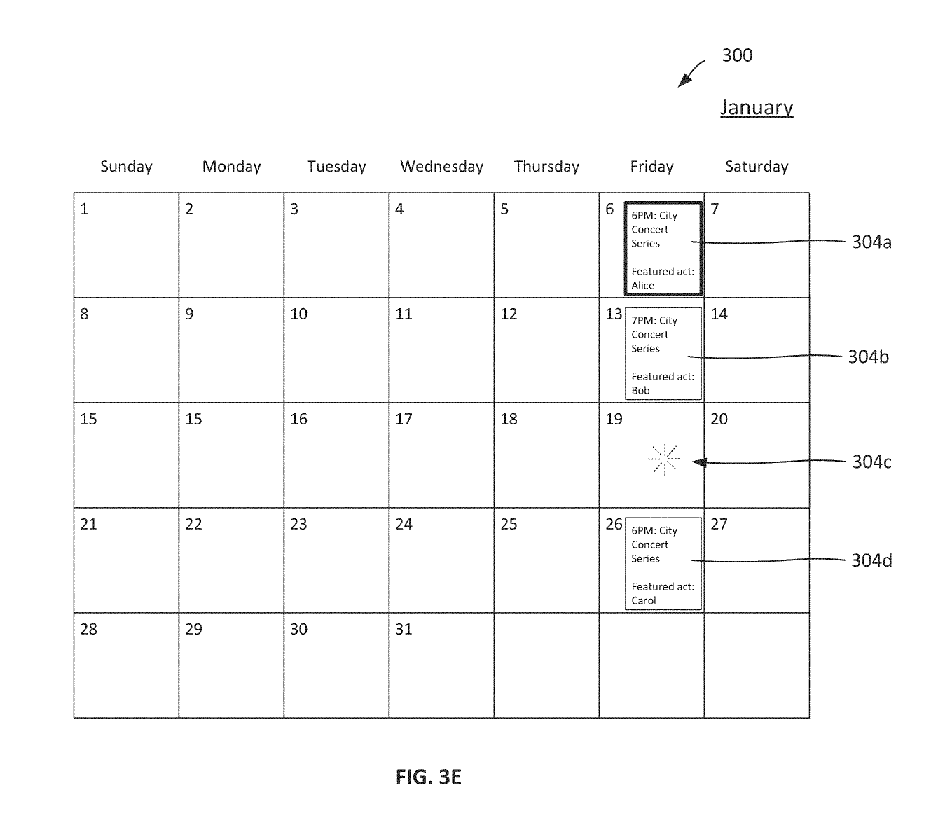

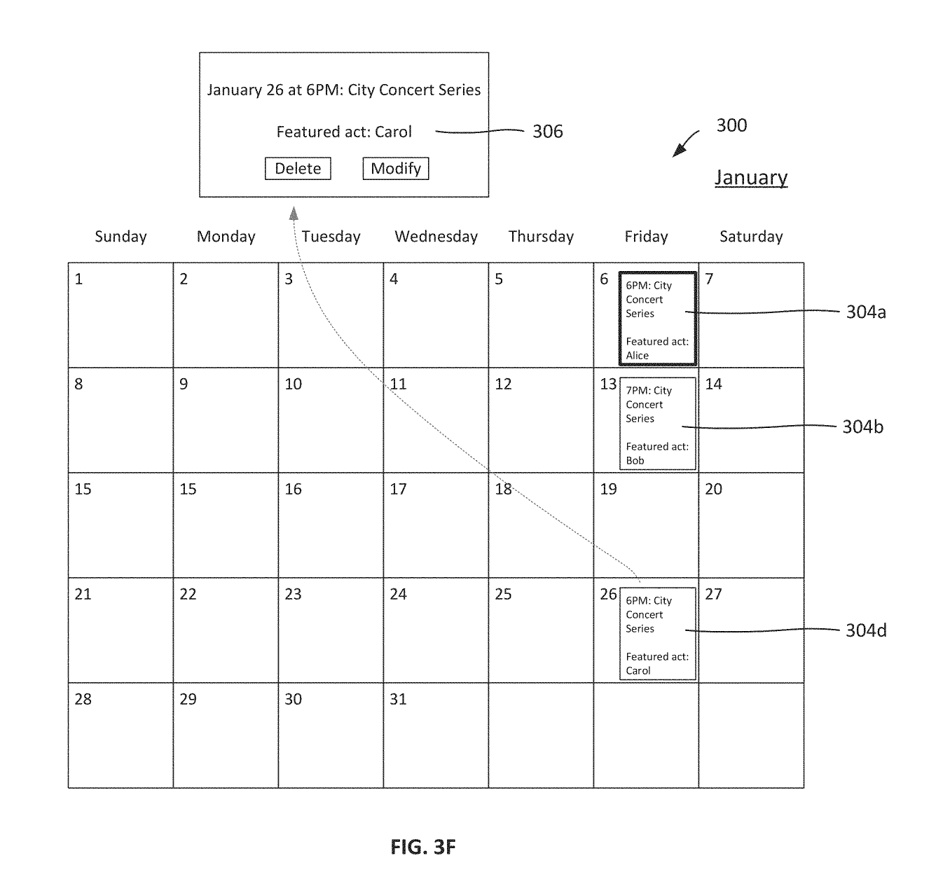

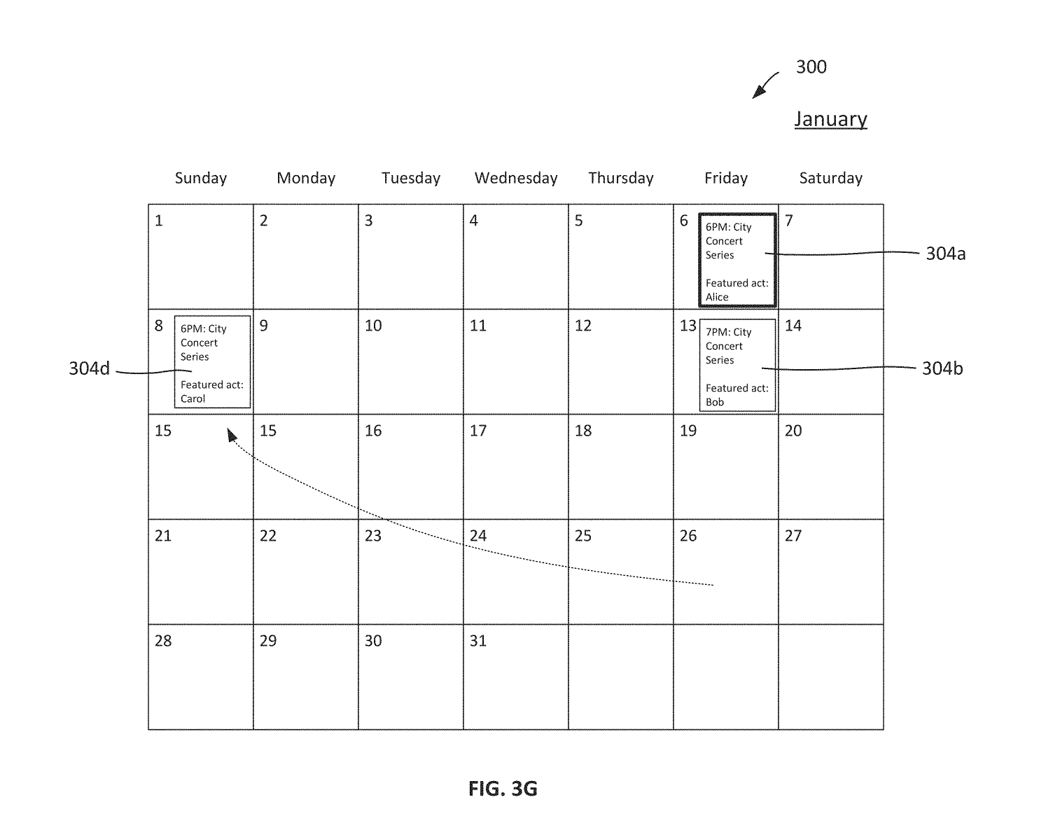

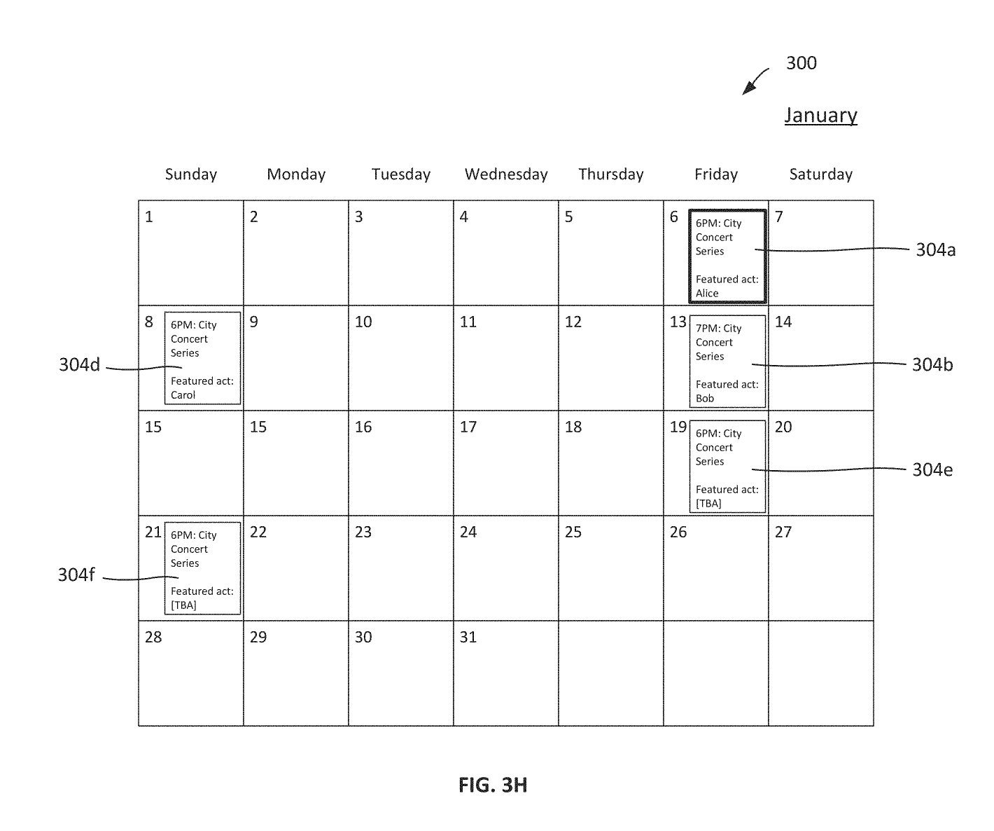

As described above, one or more implementations of the social media platform 150 enable a user to promote and organize events in an automated manner. An example of this functionality is illustrated in FIGS. 3A-3H.

A social media platform 150 can store information regarding one or more events. For instance, each event can be represented in a calendar. An example calendar 300 is shown in FIG. 3A (e.g., representing the month of January). In FIG. 3A, the calendar 300 does not yet include any events.

To add events to the calendar 300, a user can interact with the social media platform 150 to create an event template for a recurring series of events. The user can populate the event template with information common to each of the events in the series. Further, the user can specify a recurring schedule for the events. Based on the event template, the social media platform generates a series of social media event items and stores them in the database (e.g., in the database module 202 of FIG. 2).

An example event template 302 is shown in FIG. 3B. The event template 302 can be similar to the event template 212 described with respect to FIG. 2. For example, the event template 302 includes information common to each of the events in the series. In some cases, this can be referred to as “default” content, or content that is automatically associated with each of the events, subject to further revision by the user in the future. For example, the event template 302 specifies a default textual title for each of the events in the series (e.g., “City Concert Series”). Further, the event template 302 includes default content for each of the events in the series (e.g., a textual description “Featured act: [TBA]”). Further, the event template 302 includes a recurring schedule for the events (e.g., “Every Friday at 6 PM”). This information can be inputted, for example, by a user while interacting with the social media platform 150.

Although example information is shown in FIG. 3B, this is merely an illustrative example. In practice, an event template can include additional information, either in addition to or instead of the information shown. As an example, an event template can also include data specifying a default duration of an event and/or a default ending time of an event. As another example, an event template can include data specifying the beginning date of the series of events (e.g., the date of the first event in the series, or a bounding date prior to the first event in the series) and/or the ending date of the series of events (e.g., the date of the last event in the series, or a bounding date after the first event in the series). As another example, an event template can include textual information, images, videos, audio, and/or other content relating to the event. As another example, an event template can include information specifying the default controlling users of the event and/or the default invitees to the event.

In response to the user creating the event template 302, the social media platform 150 generates one or more event items, stores the event items, and places the events represented by the event items on the calendar 300. For example, as the event template 302 specifies a referring schedule of “every Friday at 6 PM,” the social media platform 150 generates several events 304a-d for the month of January, indicating that events occur every Friday at 6 PM. In addition, the social media platform 150 incorporates the default title and the default content from the event template 302 into each of the events 304a-d. This can be beneficial, for example, as it enables a user to quickly and efficiently create multiple different event items, without requiring that the user manually input information regarding each event individually (e.g., without requiring the user to manually input a title and content for each event individually).

Further, the social media platform 150 can assign a publication state to each of the events 304a-d. For example, each event item corresponding to a respective event 304a-d can be assigned an “inactive” state, indicating that the event item corresponding to the respective event 304a-d is accessible by controlling users of the event (e.g., one or more users responsible for creating, organizing, scheduling, rescheduling, administrating, and/or publicizing the event), but not accessible by users in the general public. This can be useful, for example, as it enables the controlling users of the event to privately view and/or modify event items (e.g., “draft” or tentative event items) prior to making them accessible to the general public.

As another example, each event item corresponding to a respective event 304a-d can be assigned an “active” state, indicating that the event item corresponding to the respective event 304a-d is accessible by controlling users of the event, as well as by users in the general public. This can be useful, for example, as it enables the controlling users to publicize information regarding finalized events to the general public.

In some cases, the social media platform 150 can initially assign each newly generated event item an “inactive state.” For example, as shown in FIG. 3B, each of events 304a-d has been assigned an “inactive state” (represented by a thin outline), indicating that the controlling users of the events can view and/or modify the underlying event items, but the event items are not accessible by general users.

The user can individually modify one or more of the generated event items corresponding to a respective event 304a-d. For example, as shown in FIG. 3C, the user has modified the textual content of an event 304a (e.g., such that the textual description reads “Featured act: Alice”). Further, the user has modified the publication state of the event item corresponding to the event 304a, such that it is “active” (represented by a thick outline). Thus, general users can view the event 304a. Further, the user has modified the scheduled beginning time of the event 304b (e.g., such that it begins at 7 PM, rather than 6 PM), and the textual content of the event 304b (e.g., such that the textual description reads “Featured act: Bob”). Further, the user has modified the textual content of the event 304d (e.g., such that the textual description reads “Featured act: Carol”). In this example, the event item corresponding to the event 304c has remained unchanged in the database.

The user can also modify the event template 302. In response, the social media platform 150 can automatically modify one or more of the event items corresponding to the events 302a-d to reflect changes to the event template 302. In some cases, the social media platform 150 can automatically modify two or more of the event items in conjunction. This can be beneficial, for example, as it enables the user to modify multiple event items more quickly and efficiently.

For example, as shown in FIG. 3D, the user has modified the event template 302. In particular, the user has modified the recurring schedule to specify that events are to occur every other Friday at 6 PM (instead of every Friday at 6 PM). Further, the user has modified the recurring schedule to specify that events are also to occur every other Sunday at 6 PM, beginning January 6^{th}.

In response, the social media platform can reschedule one or more of the events 304a-d (e.g., transmit a query to the database modifying the stored date and time associated with each of the event items) to reflect the modified schedule. Further, instead of simply modifying each and every event in the series to reflect the new schedule, the social media platform can selectively reschedule, retain, and/or delete one or more of the events 304a-d according to one or more data processing rules (e.g., the data processing rules 216), such that the events 304a-d are automatically modified and/or arranged in a manner that is more useful for the user. Further, the social media platform can automatically identify one or more event conflicts resulting from the modification, and notify the user of the conflicts such that the user can address them.

For example, the social media platform 150 can categorize each of the events 304a-d into one of three categories: “unmodified,” “modified,” and “manual.” Further, the social media platform 150 can perform different operations with respect to event items in each of the categories.

The “unmodified” category can refer to event items in which the information contained within the event item remains the same as the original default information specified by the event template. Further, each of the event items in the “unmodified” category has an “inactive” publication state. From a practical perspective, this can refer to events in which the user has neither changed any of the default information specified by the event template, nor “activated” the event for viewing by the general public.

For instance, if the user specifies certain default information in the event template (e.g., a default title, default content, and a default start time), the social media platform 150 automatically generates a series of event items that includes the default information. If the user does not subsequently modify a particular event item and does not change the publication state of that event item to “active,” that event item can be considered an “unmodified” event item. As an example, referring to FIG. 3D, the event item corresponding to event 304c is an “unmodified” event item with respect to the original event template 302.

The “modified” category can refer to event items in which the information contained within the event item differs from the original default information specified by the event template. However, the start time of the event item remains the same as the original default start time specified in the event template, and is inconsistent with the modified recurring schedule. Further, each of the event items in the “modified” category has an “inactive” publication state. From a practical perspective, this can refer to “inactive” events that are not in agreement with the modified recurring schedule. Further, for these events, the user has changed certain information regarding the event, but not the original default starting time specified by the event template.

For instance, if the user specifies certain default information in the event template (e.g., a default title, default content, and a default start time), the social media platform 150 automatically generates a series of event items that includes the default information. If the user subsequently modifies the titles and/or the content of a particular event item, but maintains the original default start time and the “inactive” publication state for the event item, that event item can be considered a “modified” event item. As an example, referring to FIG. 3D, the event item corresponding to event 304d is a “modified” event item with respect to the original event template 302.

The “manual” category can refer to event items in which the start time differs from the default start time specified by the event template. The “manual” category also includes event items that have an “active” publication state. From a practical perspective, this can refer to events that have been “activated” for viewing by the general public and/or have been rescheduled from the default time specified in the event template.

For instance, if the user specifies certain default information in the event template (e.g., a default title, default content, and a default start time), the social media platform 150 automatically generates a series of event items that includes the default information. If the user subsequently modifies the start time of a particular event item and/or changes the publication state of the event item to “active,” the event item can be considered a “manual” event item. As an example, referring to FIG. 3D, the event items corresponding to events 304a and 304b are “manual” event items with respect to the original event template 302.

After the social media platform 150 has categorized each of the event items corresponding to events 304a-d, the social media platform 150 can perform different operations with respect to each of the event items corresponding to events 304a-d based on their categorization.

Event items classified as “unmodified” event items can be deleted. As an example, referring to FIG. 3D, the event item corresponding to event 304c is an “unmodified” event item with respect to the original event template 302. As shown in FIG. 3E, the event item corresponding to event 304c can be deleted (e.g., removed from the calendar 300).

Further, the social media platform 150 can notify the user regarding each of the event items classified as “modified” event items, and prompt the user to provide a new starting time. In some cases, the social media platform 150 can generate a notification, and present the notification to the user. A notification can be, for example, an indication that presents information to the user (e.g., a visual and/or an auditory alert that presents information regarding each of the “modified” event items to the user). In some cases, a notification can also solicit a user for input. For example, a notification can include one or more display elements (e.g., dialog boxes, input fields, buttons, etc.) that enable a user to input information in response to the notification. In some cases, the user can provide instructions to the social media platform 150 for processing the “modified” event items.

As an example, referring to FIG. 3D, the event item corresponding to event 304d is a “modified” event item with respect to the original event template 302. As shown in FIG. 3F, the social media platform 150 can generate a notification 306 regarding the event item corresponding to event 304d. The notification 306 includes information regarding the event item corresponding to event 304d (e.g., the starting time, the title, and the content describing the event item), and a prompt to either delete the event item corresponding to event 304d, or modify the event item corresponding to event 304d (e.g., modify the starting time of the event item corresponding to event 304d). In this example, the user has opted to revise the start time to Sunday, January 8^{th} and 6 PM. As shown in FIG. 3G, the social media platform 150 modifies the event item corresponding to event 304d to reflect the new starting time. If a series of events includes multiple “modified” event items, multiple notifications can be presented to the user (e.g., concurrently or sequentially), such that the user can delete and/or modify each of the “modified” event items.

Event items classified as “manual” event items can be maintained in their current time slot. As examples, referring to FIG. 3D, the event items corresponding to events 304a and 304b are “manual” event items with respect to the original event template 302. Accordingly, the event items corresponding to events 304a and 304b can be maintained in their time slots on the calendar 300.

After event items in each of the categories has been processed, new event items can be generated in accordance with the revised recurring schedule of the event template. For example, as shown in FIG. 3D, the user revised the recurring schedule of the event template 302 to specify that events occur every other Friday at 6 PM, and every other Sunday of 6 PM, beginning January 6^{th}. After each of the categories of event items has been processed (e.g., as shown in FIGS. 3E-3G), the resulting series of event items is still missing event items for January 19^{th} at 6 PM (i.e., every other Friday at 6 PM) and January 21^{at} at 6 PM (i.e., every other Sunday at 6 PM). Accordingly, the social media platform 150 can generate new event items corresponding to events 304e and 304f for each of these scheduled times, respectively (e.g., as shown in FIG. 3H).

In some cases, the social media platform 150 can generate one or more new event items in accordance with a revised recurring schedule (e.g., if one or more time slots specified by the revised recurring schedule do not yet have a corresponding event item). In some cases, the social media platform 150 may not generate any new event items in accordance with a revised recurring schedule (e.g., if each of the time slots specified by the revised recurring schedule already have a corresponding event item).

In some cases, the social media platform 150 can initially categorize each of the event items as “unmodified,” “modified,” or “manual” event items, then generate a notification to the controlling user of each of the “modified” event items, prompting the controlling user to provide a modified start time for each “modified” event item (e.g., as shown in FIG. 3F). Upon receiving a response from the controlling user (e.g., a response specifying the modified start time(s) and/or specifying deletion(s) of the “modified” event item(s)), the server system can subsequently delete the “unmodified” event item(s) (as shown in FIG. 3E), modify and/or delete the “modified” event item(s) in accordance with the controlling user's instructions (e.g., as shown in FIG. 3G), and add one or more additional social media event items to the series of social media event items based on the modified recurring schedule (e.g., as shown in FIG. 3H). In the event that the user does not respond to the notification or opts to “cancel” the rescheduling operation (e.g., by inputting a “cancel” command), the system can maintain each of the social media event items as is. In this manner, the social media platform 150 does not modify the series of social media events until it receives input from the user confirming that he wishes to proceed with the rescheduling operation.

Processing event items in this manner can provide various benefits. For example, instead of simply modifying each and every event in the series to reflect a new or revised recurring schedule, the social media platform can selectively reschedule one or more of the events in the series according to one or more data processing rules, such that the events are automatically rescheduled in a manner that is more useful for the user. For instance, “unmodified” event items are less likely to be of importance to a user (e.g., as the user has not individually revised the event item in any way). Thus, the social media platform 150 can automatically delete those event items without negatively impacting the efforts of the user. Further, “modified” event items are more likely to be of importance to a user (e.g., as the user has modified at least some of the content of the event item). Thus, the social media platform 150 can automatically prompt the user for instructions for each of those event items, such that event items are not deleted or changed against the user's wishes. Further, “manual” event items are even more likely to be of importance to a user (e.g., as the user has already specified that the event item be publicized to the general public and/or the user has manually specified a modified start time for that event item). Thus, the social media platform 150 can automatically retain each of these event items, such that the user's efforts are not disturbed. Thus, the social media platform 150 can automate the processing of creating, editing, and delete a series of events, e.g., by automatically carrying out database actions that update their corresponding event items, such that a user can perform these tasks more quickly and efficiently.

Although a usage of the social media platform 150 is shown in FIGS. 3A-3H, it is understood that this is merely an illustrative example. In practice, a user can interact with the social media platform 150 in different ways to create, modify, and/or delete a series of event items.

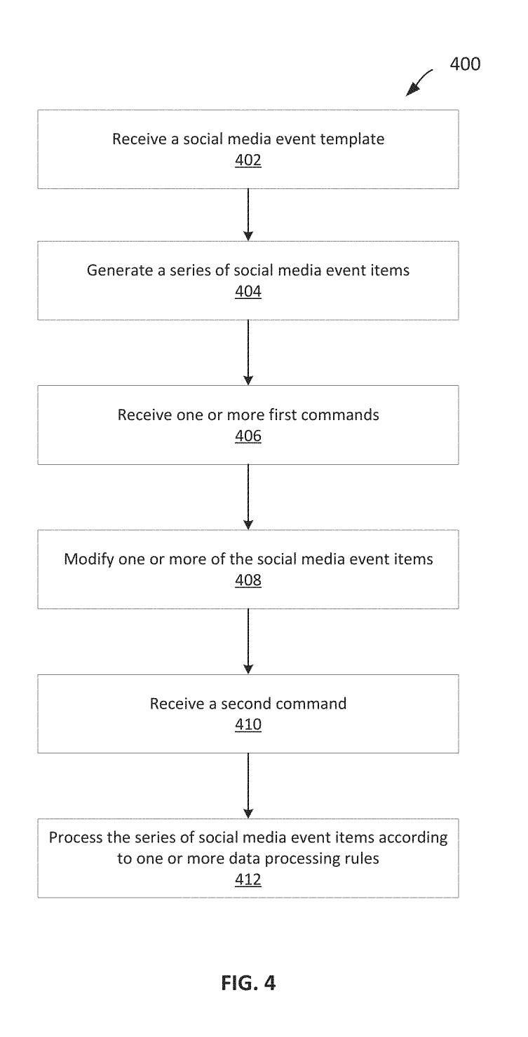

FIG. 4 shows an example process 400 for generating and modifying a series of event items. For example, the process 400 can be carried out by the social media platform 150 of FIGS. 1 and 2.

A server system receives a social media event template (step 402). For example, the template may be the social media event template 212 of FIG. 2 or the social media event template 302 of FIG. 3B. The social media event template includes template social media event content, and an indication of a recurring schedule.

As described herein, the template social media event content can include textual information, videos, images, audio, and/or other content pertaining to the series of events. As examples, the template social media event content can include a title, a textual description, one or more images, one or more audio files, and/or one or more video files.

As described herein, the recurring schedule can specify a repeating pattern for a series of events. For instance, the recurring schedule can include an indication of one or more recurring days of week, an indication of one or more recurring times, and/or an indication of a frequency of occurrence. For example, the recurring schedule can specify that a series of events occurs every nth day at a particular time (e.g., every day at 9 AM, every weekday at 10 PM, every Monday at 2 PM, every other Tuesday at 5 PM, etc.). As another example, the recurring schedule can specify that a series of events occurs every nth day of the month at a particular time (e.g., every first Sunday of the month at 3 PM, every second Saturday of the month at 7 PM, etc.). In practice, other recurring patterns are possible, depending on the implementation.

The server system generates, in a calendar database, a series of social media event items based on the social media event template (step 404). For example, the event items be the social media event items 210 of FIG. 2. As another example, the calendar database can be the database module 202 of FIG. 2.

As described herein, each social media event item can include an indication of a start time and a duration of the social media event item according to the recurring schedule. As an example, a social media event item can indicate that an event is scheduled to occur on February 6^{th} from 6 PM to 8 PM.

As described herein, each social media event item can also include a copy of the template social media event content. For instance, if the social media event template includes a particular title, textual description, and image, each social media event item can also include the same title, textual description, and image.

As described herein each social media event item can also include an indication of a state of the social media event item. As an example, a social media event item can include an indication of an inactive state (e.g., indicating that the social media event item is accessible by a controlling user of the social media event item and hidden from one or more general users). As another example, a social media event item can include an indication of an active state (e.g., indicating that the social media event item is accessible by the controlling user of the social media event item and accessible by the one or more general users). In some cases, each social media event item is initially assigned an inactive state upon generation. In some cases, the server system can receive a command (e.g., from a user) to activate a particular social media event item, and in response to the command, can assign the particular social media event item an active state.

The server system receives one or more first commands (step 406). Each of the one or more first commands includes an indication of a respective modification to one of the social media event item of the series of social media event items. For example, the one or more first commands can be inputted by a user, and can specify that the social media event item be modified in some way (e.g., change the title of the event item, change the content of the event item, change the rescheduled time for the event item, and/or other changes). Examples of these commands are shown and described with respect to FIG. 3C.

In response, the server system modifies one or more of the social media event items of the series of social media event items according to the one or more first commands (step 408). For example, the server system can change the title of the event item, change the content of the event item, change the scheduled time for the event item, and/or make other changes accordance with the user's instructions. Example modifications are shown and described with respect to FIG. 3C.

The server system receives a second command (step 410). The second command includes an indication of a modified recurring schedule for the social media event template. For example, if the social media event template initially indicated that the series of events was to occur every Monday at 6 PM, a second command might indicate that the series of events is instead to occur every Tuesday at 8 PM. An example command is shown and described with respect to FIG. 3D.

In response, the series of events is processed according to one or more data processing rules (step 412).

For instance, the server system can categorize each of social media event items into one of several categories. As an example, the server system can identify one or more first social media event items of the series of social media event items that have not been modified according to the one or more first commands, where first social media event has been assigned an inactive state (e.g., an “unmodified” category). As an example, referring to FIG. 3D, the event item corresponding to event 304c is an “unmodified” event item with respect to the original event template 302.

As another example, the server system can identify one or more second social media event items of the series of social media event items that have been modified according to the one or more first commands, where each second social media event item has a start time that has not been modified according to the one or more first commands, where each second social media event item has been assigned an inactive state, and where each second social media event item differs from the modified recurring schedule (e.g., a “modified” category). As an example, referring to FIG. 3D, the event item corresponding to event 304d is a “modified” event item with respect to the original event template 304.

As another example, the server system can identify one or more third social media event items of the series of social media event items that differs from the original start time specified by the event template and/or has been assigned to an “active” state (e.g., a “manual” category). As examples, referring to FIG. 3D, the event items corresponding to events 304a and 304b are “manual” event items with respect to the original event template 302.

After the server system has categorized each of the social media event items, the server system can perform different operations with respect to each of the social media event items based on their categorization.

For example, the one or more first social media event items (e.g., “unmodified” event items) can be deleted. An example deletion is shown and described with respect to FIG. 3E (e.g., the deletion of the event item corresponding to the event 304c).

As another example, for each of the one or more second social media event items (e.g., “modified” event items), the server system can generate a respective notification to a controlling user of the second social media event item, prompting the controlling user to provide a modified start time for the second social media event item. In some cases, the notification can also include a user selectable option to delete the second social media event item. The server system can modify the one or more second social media event items based on the controlling user's response (e.g., by modifying the start time of the second social media event item, or deleting the social media event item). An example notification is shown and described with respect to FIG. 3F, and an example modification is shown and described with respect to FIG. 3G.

As another example, each of the one or more third social media event items (e.g., “manual” event items) can be maintained without change.

Further, the server system can add one or more additional social media event items to the series of social media event items based on the modified recurring schedule. For instance, after each of the categories of event items has been processed, the resulting series of event items might still be missing event items for certain time slots specified by the modified recurring schedule. If so, the server system can generate new event items for each of these scheduled times, respectively. As an example, the server system can determine that the series of social media event items does not include one or more social media event items corresponding to the modified recurring schedule. Based on the determination, the server system can add the one or more additional social media event items to the series of social media event items corresponding to the modified recurring schedule. As an example, FIG. 3H shows the adding of social media event items in accordance with a modified recurring schedule.

In some cases, the server system can initially generate a respective notification to the controlling user of each second social media event item, prompting the controlling user to provide a modified start time for each second social media event item. Upon receiving a response from the controlling user (e.g., a response specifying the modified start time(s) and/or specifying deletion(s) of the second social media event item(s)), the server system can subsequently delete the one or more first social media event items (e.g., “unmodified” event items), modify and/or delete the one or more second social media event items in accordance with the controlling user's instructions, and add one or more additional social media event items to the series of social media event items based on the modified recurring schedule. In the event that the user does not respond to the notification or opts to “cancel” the rescheduling operation (e.g., by inputting a “cancel” command), the system can maintain each of the social media event items as is. In this manner, the server system does not modify the series of social media events until it receives input from the user confirming that he wishes to proceed with the rescheduling operation.

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, the server system 102, the platform 150, and the client devices 104a-c can be implemented using digital electronic circuitry, or in computer software, firmware, or hardware, or in combinations of one or more of them. In another example, the process 400 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

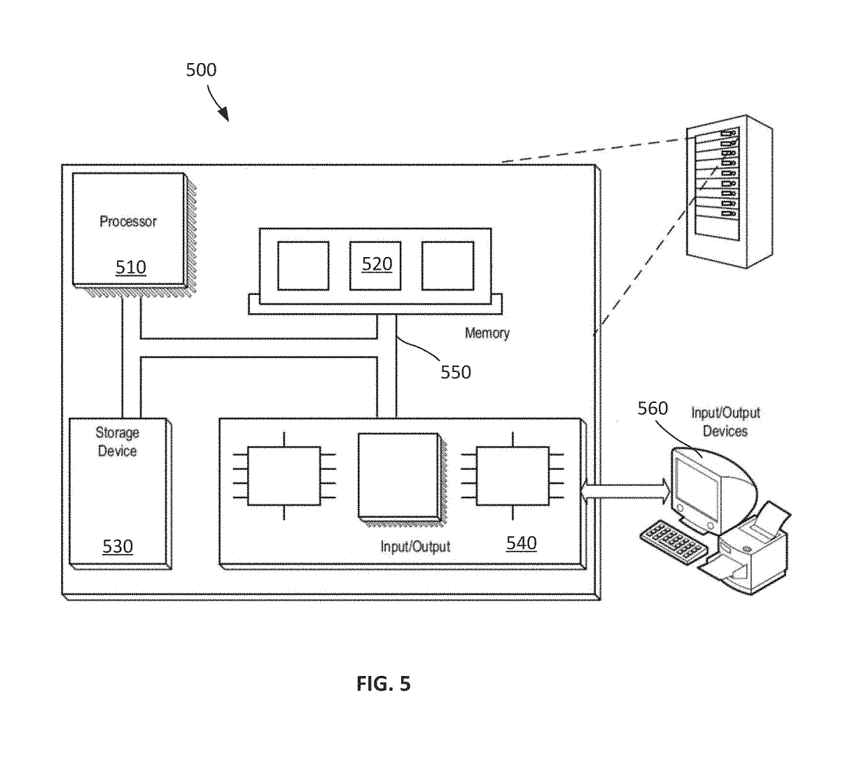

FIG. 5 shows an example computer system 500 that includes a processor 510, a memory 520, a storage device 530 and an input/output device 540. Each of the components 510, 520, 530 and 540 can be interconnected, for example, by a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of implementations have been described. Nevertheless, it will be understood that various modifications may be made without departing from the spirit and scope of the invention. Accordingly, other implementations are within the scope of the following claims.

What is claimed is:

1. A method comprising:
receiving, at a server system, a social media event template, the social media event template comprising:
template social media event content, and
an indication of a recurring schedule;
generating, by the server system in a calendar database, a series of social media event items based on the social media event template, wherein each social media event item comprises:
an indication of a start time and a duration of the social media event item according to the recurring schedule,
a copy of the template social media event content, and
an indication of a state of the social media event item, the state being one of:
an inactive state indicating that the social media event item is accessible by a controlling user of the social media event item and hidden from one or more general users, and
an active state indicating that the social media event item is accessible by the controlling user of the social media event item and accessible by the one or more general users;
receiving, at the server system, one or more first commands, wherein each of the one or more first commands comprises an indication of a respective modification to one of the social media event item of the series of social media event items;
responsive to receiving the one or more first commands, modifying one or more of the social media event items of the series of social media event items according to the one or more first commands;
receiving, at the server system, a second command, the second command comprising an indication of a modified recurring schedule for the social media event template;
responsive to receiving the second command:
identifying one or more first social media event items of the series of social media event items that have not been modified according to the one or more first commands, each first social media event item having an inactive state;
identifying one or more second social media event items of the series of social media event items that have been modified according to the one or more first commands, each second social media event item having a start time that has not been modified according to the one or more first commands, each second social media event item having an inactive state, and each second social media event item differing from the modified recurring schedule;
generating, for each of the one or more second social media event items, a notification to the controlling user of the second social media event item, the notification prompting the controlling user to provide a modified start time for the second social media event item;
receiving, for each of the one or more second social media event items, a response from the controlling user of the second social media event item specifying the modified start time; and
subsequent to generating the notification and receiving the response for each of the one or more second social media event items:
deleting the one or more first social media event items; and
adding one or more additional social media event items to the series of social media event items based on the modified recurring schedule.

2. The method of claim 1, wherein adding the one or more additional social media event items to the series of social media event items comprises:
determining that the series of social media event items does not include one or more social media event items corresponding to the modified recurring schedule, and
based on the determination, adding the one or more additional social media event items to the series of social media event items corresponding to the modified recurring schedule.

3. The method of claim 1, wherein each social media event item is initially assigned an inactive state upon generation.

4. The method of claim 3, further comprising:
receiving, at the server system, a command to activate a particular social media event item; and
responsive to receiving the command to activate the particular social media event item, assigning the particular social media event item an active state.

5. The method of claim 1, wherein the notification further comprises a user selectable option to delete the second social media event item.

6. The method of claim 1, wherein the indication of the recurring schedule comprises an indication of one or more recurring days of week.

7. The method of claim 1, wherein the indication of the recurring schedule comprises an indication of one or more recurring times.

8. The method of claim 1, wherein the indication of the recurring schedule comprises an indication of a frequency of occurrence.

9. The method of claim 1, wherein the template social media event content comprises at least one of text, an image, a video, or audio pertaining to the series of social media event items.

10. A method comprising:
receiving, at a server system, a social media event template, the social media event template comprising:
template social media event content, and
an indication of a recurring schedule;
generating, by the server system in a calendar database, a series of social media event items based on the social media event template, wherein each social media event item comprises:
an indication of a start time and a duration of the social media event item according to the recurring schedule, and
a copy of the template social media event content;
receiving, at the server system, one or more first commands, wherein each of the one or more first commands comprises an indication of a respective modification to one of the social media event item of the series of social media event items;
responsive to receiving the one or more first commands, modifying one or more of the social media event items of the series of social media event items according to the one or more first commands;
receiving, at the server system, a second command, the second command comprising an indication of a modified recurring schedule for the social media event template;
responsive to receiving the second command:
identifying a particular social media event item of the series of social media event items based on a determination that the particular social media event item that has been modified according to the one or more first commands and has a start time that has not been modified according to the one or more first commands;
generating, for the particular social media event item, a notification to the controlling user of the particular social media event item, the notification prompting the controlling user to provide a modified start time for the particular social media event item.

11. The method of claim 10, wherein each social media event item further comprises an indication of a state of the social media event item, the state being one of:
an inactive state indicating that the social media event item is accessible by a controlling user of the social media event item and hidden from one or more general users, and
an active state indicating that the social media event item is accessible by the controlling user of the social media event item and accessible by the one or more general users, and
wherein identifying the particular social media event item of the series of social media event item is further based on a determination that the particular social media event item has an inactive state.

12. The method of claim 11, further comprising:
identifying a second social media event item of the series of social media event items that has not been modified according to the one or more first commands, the second social media event item having an inactive state; and
deleting the second social media event item.

13. The method of claim 11, wherein deleting the second social media event item occurs subsequent to generating the notification to the controlling user of the particular social media event item and receiving a response from the controlling user specifying the modified start time.

14. The method of claim 11, wherein each social media event item is initially assigned an inactive state upon generation.

15. The method of claim 11, further comprising:
receiving, at the server system, a command to activate one of the social media event items; and
responsive to receiving the command, assigning that social media event item an active state.

16. The method of claim 10, wherein the notification further comprises a user selectable option to delete the particular social media event item.

17. The method of claim 10, further comprising:
receiving the modified start time from the controlling user of the particular social media event item; and
modifying the particular social media event item based on the received modified start time.

18. The method of claim 10, further comprising adding one or more additional social media event items to the series of social media event items based on the modified recurring schedule.

19. The method of claim 18, wherein adding the one or more additional social media event items to the series of social media event items occurs subsequent to generating the notification to the controlling user of the particular social media event item and receiving a response from the controlling user specifying the modified start time.

20. A non-transitory computer-readable medium including one or more sequences of instructions which, when executed by one or more processors, causes:
receiving, at a server system, a social media event template, the social media event template comprising:
template social media event content, and
an indication of a recurring schedule;
generating, by the server system in a calendar database, a series of social media event items based on the social media event template, wherein each social media event item comprises:
an indication of a start time and a duration of the social media event item according to the recurring schedule,
a copy of the template social media event content, and
an indication of a state of the social media event item, the state being one of:
an inactive state indicating that the social media event item is accessible by a controlling user of the social media event item and hidden from one or more general users, and
an active state indicating that the social media event item is accessible by the controlling user of the social media event item and accessible by the one or more general users;
receiving, at the server system, one or more first commands, wherein each of the one or more first commands comprises an indication of a respective modification to one of the social media event item of the series of social media event items;
responsive to receiving the one or more first commands, modifying one or more of the social media event items of the series of social media event items according to the one or more first commands;
receiving, at the server system, a second command, the second command comprising an indication of a modified recurring schedule for the social media event template;
responsive to receiving the second command:
identifying one or more first social media event items of the series of social media events that have not been modified according to the one or more first commands, each first social media event item having an inactive state;
identifying one or more second social media event items of the series of social media event items that have been modified according to the one or more first commands, each second social media event item having a start time that has not been modified according to the one or more first commands, each second social media event item having an inactive state, and each second social media event item differing from the modified recurring schedule;
generating, for each of the one or more second social media event items, a notification to the controlling user of the second social media event item, the notification prompting the controlling user to provide a modified start time for the second social media event item;
receiving, for each of the one or more second social media event items, a response from the controlling user of the second social media event item specifying the modified start time; and
subsequent to generating the notification and receiving the response for each of the one or more second social media event items:
deleting the one or more first social media event items; and
adding one or more additional social media event items to the series of social media event items based on the modified recurring schedule.

21. A non-transitory computer-readable medium including one or more sequences of instructions which, when executed by one or more processors, causes:
receiving, at a server system, a social media event template, the social media event template comprising:
template social media event content, and
an indication of a recurring schedule;
generating, by the server system in a calendar database, a series of social media event items based on the social media event template, wherein each social media event item comprises:
an indication of a start time and a duration of the social media event item according to the recurring schedule, and
a copy of the template social media event content;
receiving, at the server system, one or more first commands, wherein each of the one or more first commands comprises an indication of a respective modification to one of the social media event item of the series of social media event items;
responsive to receiving the one or more first commands, modifying one or more of the social media event items of the series of social media event items according to the one or more first commands;
receiving, at the server system, a second command, the second command comprising an indication of a modified recurring schedule for the social media event template;
responsive to receiving the second command:
identifying a particular social media event item of the series of social media event items based on a determination that the particular social media event item that has been modified according to the one or more first commands and has a start time that has not been modified according to the one or more first commands; and
generating, for the particular social media event item, a notification to the controlling user of the particular social media event item, the notification prompting the controlling user to provide a modified start time for the particular social media event item.
